(19) United States
(12) Patent Application Publication
(10) Pub. No.: US 2012/0191778 A1
(43) Pub. Date: Jul. 26, 2012

(54) CONTENT DISTRIBUTION NETWORK FOR SUPPORTING PEER-TO-PEER LIVE STREAMING

(75) Inventors: Young Han KIM, Seoul (KR); Thinh Nguyen Kim, Seoul (KR)

(73) Assignees: MMC Technology Inc., Seoul (KR); Soongsil University Research Consortium Techno- Park, Seoul (KR)

(21) Appl. No.: 13/016,786

(22) Filed: Jan. 28, 2011

(30) Foreign Application Priority Data
Jan. 26, 2011 (KR) 10-2011-0007623

(51) Int. Cl. G06F 15/16

(52) U.S. Cl. 709/204

(57) ABSTRACT

Disclosed herein is a method and system for providing a Peer-to-Peer (P2P) live streaming service over a Content Distribution Network (CDN). The method includes the steps of (A) a peer present on a network searching for an adjacent surrogate, that is, a superpeer in a bin where peers are grouped, (B) the peer sending a content request message to the surrogate, (C) the surrogate finding a corresponding peer list and then sending the peer list to the peer in response to the content request message, or, if the surrogate cannot find a peer list corresponding to the content request message and makes a request to a surrogate overlay, the surrogate overlay sending information about a surrogate having corresponding content to the peer, and (D) the peer requesting content from the surrogate having sent the peer list or from a surrogate included in the information about a surrogate, and receiving the corresponding content.

### BACKGROUND OF THE INVENTION

1. Field of the Invention

The present invention relates generally to a peer-to-peer (P2P) live streaming, in particular, and, more particularly, to a method of providing an optimum P2P live streaming service among peers via a Content Distribution Network (CDN) which is based on the locality of the peers and which employs a gossip protocol and a Hierarchical-Distributed Hash Table (DHT).

2. Description of the Related Art

Although specialized Content Distribution Networks (CDNs) are being operated by Akamai, LimeLight, etc., excessively high expenses are incurred to provide content, such as video. Over such a conventional CDN, a large quantity of content can be rapidly and stably sent to peers by copying content to a distributed cache server in advance. However, the conventional CDN is easily overloaded, so that it is problematic in that requested content is delayed and then provided to remote clients late (long latency).

Accordingly, P2P is attracting attention as a perfect match which is capable of improving the conventional CDN. In the case of P2P, the more peers join the system, the greater contribution of the resources is achieved, thereby offering scalability.

As shown in FIG. 1, in current P2P live streaming, when a peer requests content from a tracker (1), the tracker sends a peer list as a response (2), so that peers exchange a peer list (3), chunk bitmaps, and find and provide chunks (4). The peers may periodically report related information, such as state information, to the tracker (5).

However, as shown in FIG. 2, inefficient routing is performed on an overlay based on the locality of the peers, and an excessively heavy substantial load is exerted on an underlying network, such as the Transmission Control Protocol/Internet Protocol (TCP/IP)-based Internet. As a result, these lead to the problem of the deterioration in the performance of searching or routing.

### SUMMARY OF THE INVENTION

Accordingly, the present invention has been made keeping in mind the above problems occurring in the prior art, and an object of the present invention is to provide a method of providing an optimum P2P live streaming service between peers via a CDN which is based on the locality of the peers and which employs a gossip protocol and a Hierarchical-DHT.

In order to accomplish the above object, the present invention provides a method of providing a P2P live streaming service over a CDN, including the steps of (A) a peer present on a network searching for an adjacent surrogate, that is, a superpeer in a bin where peers are grouped; (B) the peer sending a content request message to the surrogate; (C) the surrogate finding a corresponding peer list and then sending the peer list to the peer in response to the content request message, or, if the surrogate cannot find a peer list corresponding to the content request message and makes a request to a surrogate overlay, the surrogate overlay sending information about a surrogate having corresponding content to the peer; and (D) the peer requesting content from the surrogate having sent the peer list or from a surrogate included in the information about a surrogate, and receiving the corresponding content.

At the step (A), peers having an identical ordering of a plurality of landmarks ordered based on calculated distances between each peer to the plurality of landmarks may be grouped in the bin.

The information about a surrogate sent by the surrogate overlay may include a surrogate ID corresponding to the content and the number of peers grouped into the corresponding surrogate, which have been received from some other surrogate and are being maintained.

If each of the surrogate ID and the number of peers grouped into the corresponding surrogate may include a plurality of pieces of information, the peer may request the content from a surrogate corresponding to a surrogate ID having a largest number of grouped peers at step (D).

Each peer present on the network may maintain a peer list corresponding to each piece of content while randomly communicating with the surrogate, periodically update a view of other peers and information about a state of each peer and then stores them in memory in accordance with a gossip protocol, and provide notification thereof to the surrogate so that they can be used to select a peer list.

The surrogate overlay may divide a predetermined Control Area Network (CAN) zone based on a number of landmarks present across a network, and locate a plurality of surrogates in respective CAN zones in such a way that surrogates having an identical bin are located in an identical CAN zone, thereby determining the information about a surrogate so that close peers first belong thereto by means of locality-based awareness.

In accordance with another aspect of the present invention, there is provided a system for providing a P2P live streaming service over a CDN, including a plurality of surrogates, each of the surrogates being a superpeer in a bin in which different peers distributed across a network are grouped; and a surrogate overlay configured to manage the plurality of surrogates; wherein a found adjacent surrogate finds a corresponding peer list and then sends the peer list to the peer in response to the content request message sent to the surrogate, or, if the surrogate cannot find a peer list corresponding to the content request message and makes a request to the surrogate overlay, the surrogate overlay sends information about a surrogate having corresponding content to the peer; and wherein the peer requests content from the surrogate having sent the peer list or from a surrogate included in the information about a surrogate, and receives the corresponding content.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a current P2P live streaming service;

FIG. 2 is a diagram illustrating an existing locality-based overlay;

FIG. 3 is a diagram illustrating a binning method according to an embodiment of the present invention;

FIG. 4 is a diagram illustrating peers which constitute a surrogate overlay according to an embodiment of the present invention;

FIGS. 5A to 5C are diagrams illustrating a gossip protocol between two peers according to an embodiment of the present invention;

FIG. 6 is a diagram illustrating a surrogate according to an embodiment of the present invention;

FIG. 7A is a diagram illustrating a physical network in the surrogate overlay according to an embodiment of the present invention;

FIG. 7B is diagram illustrating the surrogate overlay for FIG. 7A;

FIG. 8 is a diagram illustrating information maintained by a surrogate according to an embodiment of the present invention; and

FIG. 9 is a flowchart illustrating the operation of a CDN system for providing a P2P live streaming service according to an embodiment of the present invention.

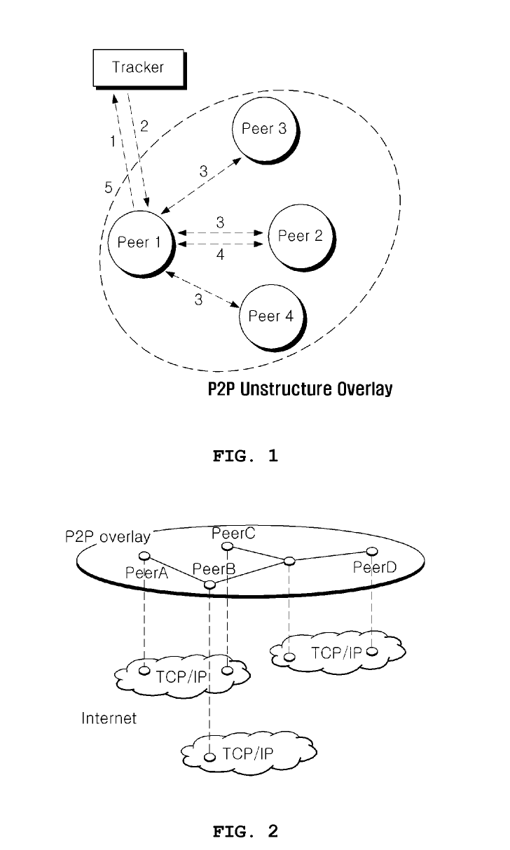

### DESCRIPTION OF THE PREFERRED EMBODIMENTS

Reference now should be made to the drawings, in which the same reference numerals are used throughout the different drawings to designate the same or similar components.

In the following description of the present invention, the term “peer” or “node” may refer to a User Agent (UA) or a client capable of communicating over a network, such as the wired or wireless Internet or a mobile communication network (such as a WCDMA network, a WiFi network or a WiBro network), and may refer to a terminal, a server, or a system. Such a peer or node may include a notebook personal computer, a desktop personal computer, a palm personal computer, a smart phone, a cellular phone, a Personal Communications Services (PCS) phone, a wireless communication-enabled synchronous/non-synchronous International Mobile Telecommunication (IMT)-2000 phone, a Personal Digital Assistant (PDA), a Wireless Application Protocol (WAP) phone, a mobile game machine, a Portable Multimedia Player (PMP), and a portable or mobile terminal, and may include various electronic devices or apparatuses for homes or businesses which are capable of communicating with other electronic devices.

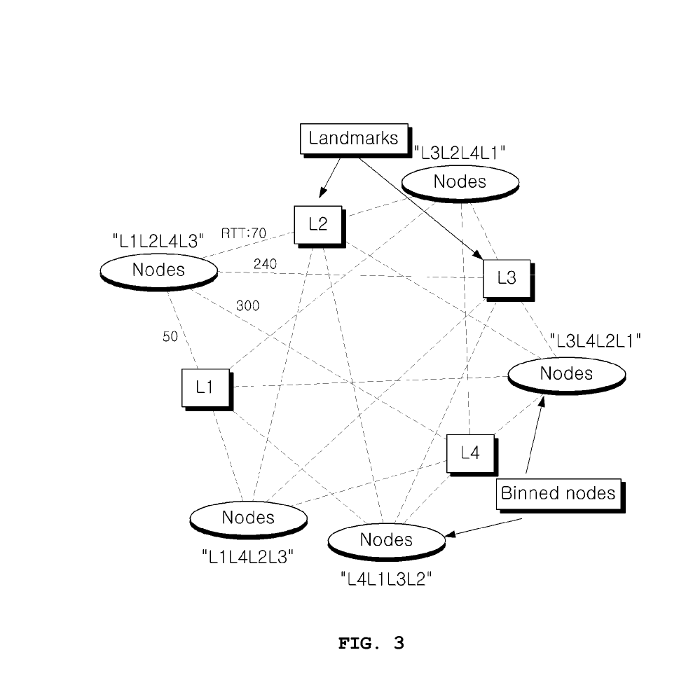

FIG. 3 is a diagram illustrating a binning method according to an embodiment of the present invention.

Referring to FIG. 3, a CDN system for providing a P2P live streaming service according to an embodiment of the present invention may include distributed peers (or nodes) and landmarks L1, L2, L3, and L4, that is, peers (or nodes) fixed among the distributed peers.

Each of the distributed peers calculates distances to the landmarks L1, L2, L3 and L4 using a Round-Trip Time (RTT) algorithm (a technique which measures the time it takes for a sent signal to return), and orders the landmarks in the order from the closest landmark to the farthest landmark based on the calculated distances. In this case, peers having the same ordering belong to the same bin. As will be described later, a surrogate, which is a superpeer representative of a bin, is present in the bin.

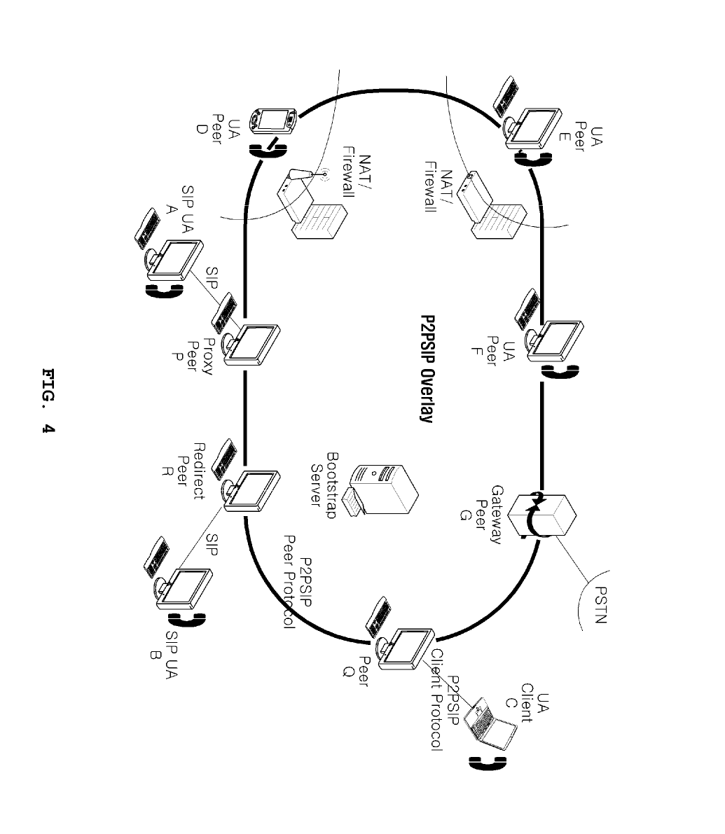

FIG. 4 is a diagram illustrating peers which constitute a surrogate overlay according to an embodiment of the present invention.

As shown in FIG. 4, in a CDN system for providing a P2P live streaming service according to an embodiment of the present invention, each peer, that is, a UA on a surrogate overlay (which may have a firewall), may share content with another peer over a network, such as the wired or wireless Internet, a mobile communication network (such as a WCDMA network, a WiFi network, or a WiBro network), or a public switched telephone network (PSTN), while communicating with it, in which case the former peer may establish a Session Initiation Protocol (SIP)-based session with a gateway or proxy peer, a redirect peer, a bootstrap server (or peer), or a general peer, access a system and receive a service.

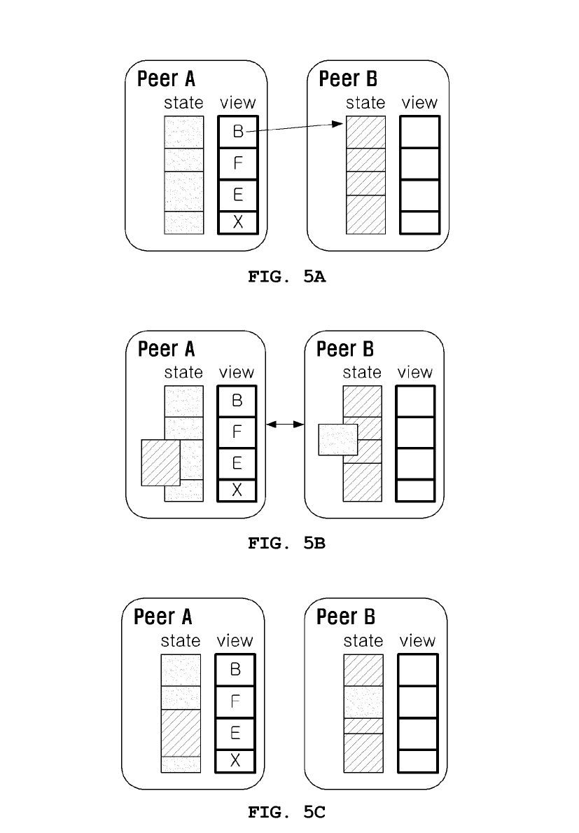

FIGS. 5A to 5C are diagrams illustrating a gossip protocol gossip protocol between two peers according to an embodiment of the present invention.

First, as shown in FIG. 5A, in the CDN system for providing a P2P live streaming service according to an embodiment of the present invention, in accordance with a gossip protocol, each peer may periodically update the view (the names or IDs of peers having content required by a UA) of other peers present in the overlay (for example, peers belonging to the same bin) and state information (for example, resource utilization rate, etc.), and store them in memory. For example, as shown in FIG. 5A, a peer A may periodically select a peer B from a view using a random method (or another predetermined method such as a sequential selection method); as shown in FIG. 5B, peers A and B exchange state information with each other in accordance with a gossip protocol; and, as shown in FIG. 5C, each peer updates state information received from a counter party peer and stores it in memory.

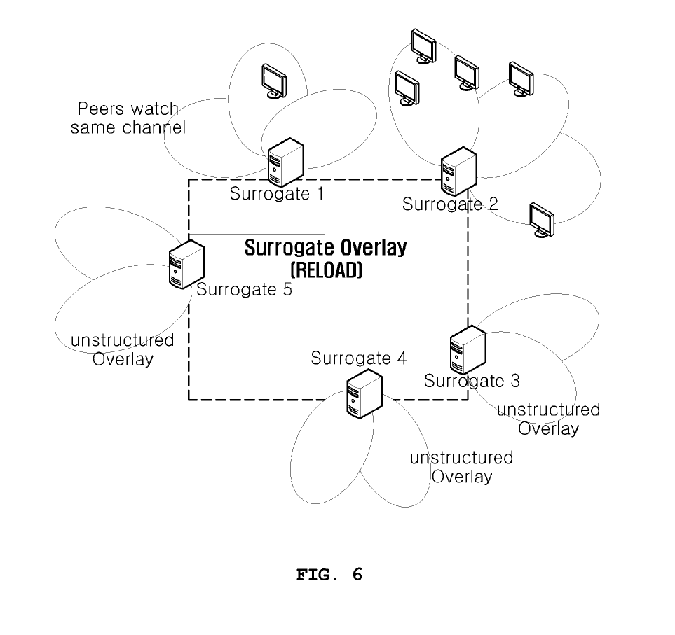

FIG. 6 is a diagram illustrating a surrogate according to an embodiment of the present invention.

As shown in FIG. 6, in the CDN system for providing a P2P live streaming service according to an embodiment of the present invention, a surrogate overlay includes a plurality of distributed surrogates, and each of the surrogates, that is, a superpeer representative of a bin, groups peers having content requested by a US at each location (for example, peers located on a unstructured overlay).

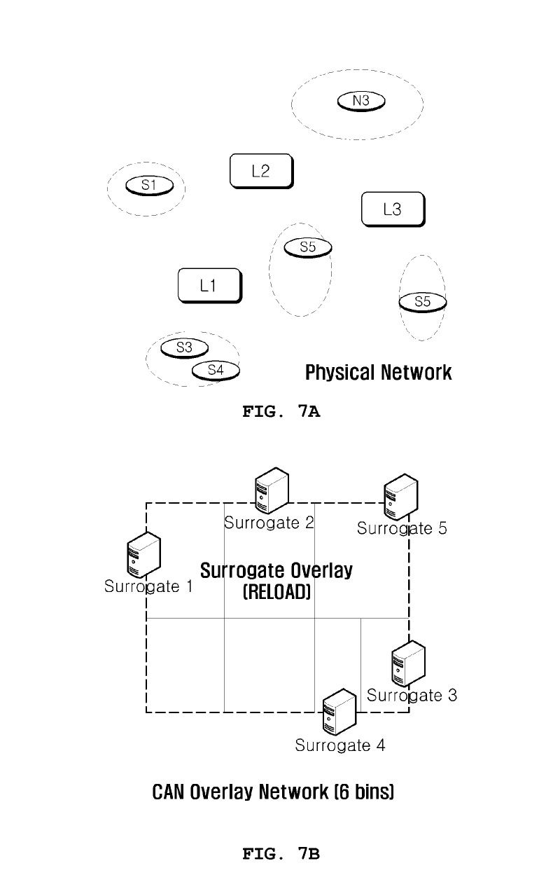

For example, it is assumed that as shown in FIG. 7A, three landmarks L1, L2 and L3 and surrogates S1, S2, S3, S4 and S5 representative of respective bins are distributed over a network. Other peers or nodes N3 which do not form groups may be further included. In this case, a surrogate overlay is divided into 3!=6 CAN zones in conformity with the number of landmarks L1, L2 and L3 and a surrogate is located in each of the zones, surrogates having the same bin may be located in the same CAN zone, as shown in FIG. 7B. Some other peer or node N3 which does not belong to a group may be located in any one CAN zone. Accordingly, the surrogate overlay can first support the sharing of content with a nearby peer using locality-based awareness when performing series data bus system structure-based data transmission using a CAN algorithm, facilitates the sharing of content among distributed peers, and can provide an optimum P2P live streaming service among peers.

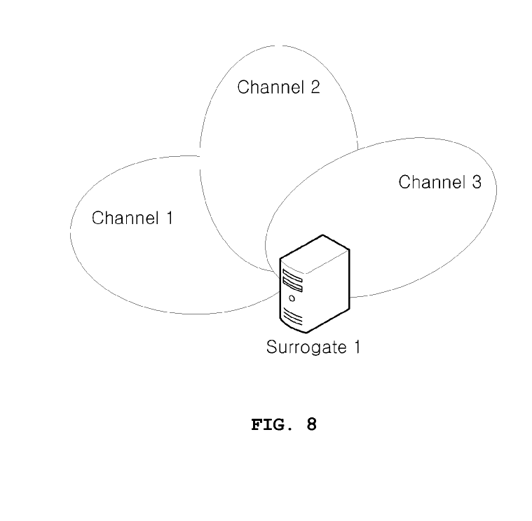

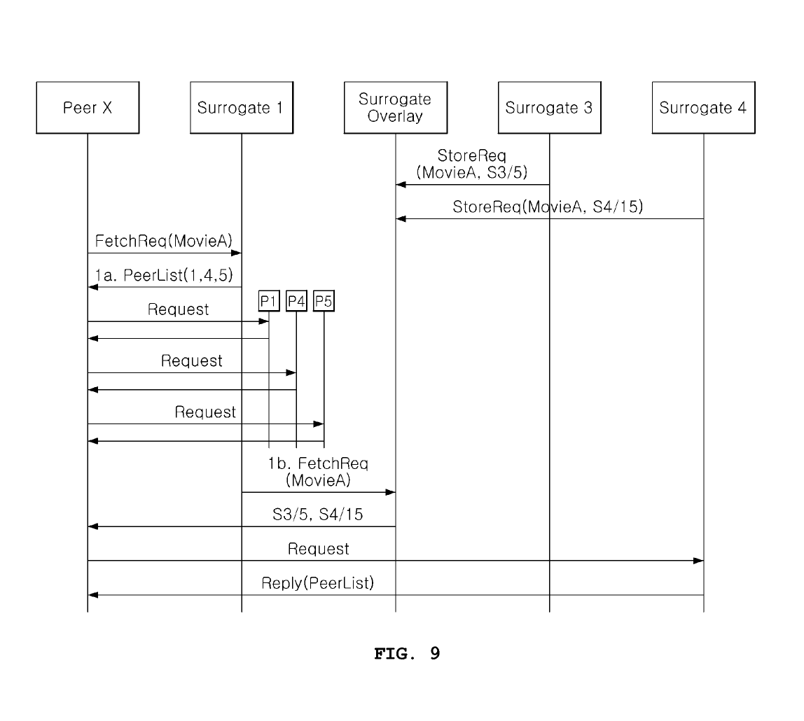

FIG. 8 is a diagram illustrating information maintained by a surrogate according to an embodiment of the present invention.

Referring to FIG. 8, the surrogate maintains information about peers corresponding to a variety of channels (or a variety of pieces of content) at each location in memory. For example, the surrogate may hash a channel name using a predetermined channel ID, maintain information about a surrogate ID corresponding to each channel ID (or content ID) and the number or a list of peers which are grouped into the corresponding surrogate in memory, and send it to the surrogate overlay, so that the surrogate overlay can also share information, for example, the surrogate ID corresponding to the channel ID (or content ID) and the number or a list of peers which are grouped into the corresponding surrogate, maintained by the surrogate.

As shown in FIG. 8, users who are watching three channels may be present in a surrogate, and the surrogate may maintain information about peers having the respective channels at the same location, like a tracker.

For example, each peer may randomly communicate with a surrogate, maintain a list of peers corresponding to channel IDs or (content IDs), and periodically update the view (the names or IDs of peers which hold content required by a UA) of the other peers (for example, peers which belong to the same bin) on the overlay and state information (for example, resource utilization rate, etc.) in compliance with a gossip protocol and store it in memory. For example, as shown in FIG. 5A, a peer A may periodically select a peer B from a view using a random method (or another predetermined method such as a sequential selection method); as shown in FIG. 5B, peers A and B exchange state information with each other in accordance with a gossip protocol; and, as shown in FIG. 5C, each peer updates state information received from a counter party peer and stores it in memory.

As described above, each of the peers on a network may maintain a list of peers corresponding to channel IDs (or content IDs), a view (the names or IDs of peers which hold content requested by a UA) of other peers and state information (for example, resource utilization rate, etc.) in the form of a Hierarchical-Distributed Hash Table (DHT), and share the information with a surrogate by communicating with the surrogate.

The surrogate may manage network information, such as the areas of peers holding content, the distances between peers, the bandwidth utilization rates of networks, or the attributes of a Border Gateway Protocol (BGP) in addition to the resource utilization rates (or example, CPU resource, memory resource, and network bandwidth resource utilization rates) of peers, like a tracker, analyze it, and then use it to select a list when other peers join or request content.

FIG. 9 is a flowchart illustrating the operation of the CDN system for providing a P2P live streaming service according to an embodiment of the present invention.

First, a new peer (peer X) may calculate distances to respective landmarks (see FIG. 3), order the landmarks in the order from the closest landmark to the farthest landmark based on the calculated distances, and search for an adjacent surrogate (for example, surrogate 1), which is a superpeer present in a bin where peers having the same ordering are present.

Thereafter, the new peer (peer X) sends a request message FetchReq to surrogate 1 to get content MovieA.

In response to this request, the surrogate 1 finds a list of peers (for example, P1, P4, and P5) corresponding to the content and sends it to peer X (1a). Accordingly, peer X may request the content from the surrogate 1, receive the content from one or more peers of the peer list (for example, P1, P4, and P5), and watch it.

However, if surrogate 1 does not find a list of peers (for example, P1, P4, and P5) corresponding to the content, the surrogate 1 requests information about a surrogate having corresponding content from the surrogate overlay (1b).

A surrogate overlay (or an overlay control apparatus which manages surrogates) receives and stores information, for example, a surrogate ID corresponding to a channel ID (or a content ID) (for example, MovieA) or the number or a list of peers grouped to the corresponding surrogate (for example, S3/5, S4/15), maintained by each surrogate (for example, surrogate 3, or 4), in response to the storage request message StoreReq of each surrogate (for example, surrogate 3 or 4), and send the surrogate ID corresponding to a channel ID (or a content ID) (for example, MovieA) or the number or a list of peers grouped to the corresponding surrogate (for example, S3/5, S4/15) to peer X in response to the request 1b. When the request 1b is made, information about peer X may be included in the corresponding request message FetchReq.

As shown in FIG. 7B, the surrogate overlay divides a predetermined Control Area Network (CAN) zone based on the number of landmarks present across a network, and locates a plurality of surrogates in respective CAN zones in such a way that surrogates having the same bin are located in the same CAN zone. Accordingly, information about the surrogate may be determined so that close peers first belong thereto by means of locality-based awareness, and, for example, the surrogate ID corresponding to the channel ID (or content ID) (for example, MovieA) and the number or a list of peers grouped into the corresponding surrogate (for example, S3/5, S4/15) may be sent.

Accordingly, peer X may select surrogate 4 having the greatest (15) of the numbers (5/15) of the peers grouped to the surrogate and request corresponding content therefrom. Accordingly, peer X may receive a corresponding peer list from the accordingly surrogate 4, request the corresponding content from one or more peers of the list, and then watch the content received from the peers.

As described above, via the CDN for providing a P2P live streaming service according to the present invention, the surrogate overlay collects information about peers managed by surrogates and then processes the requests of the peers while taking into account the locality of the peers, a gossip protocol gossip protocol and a hierarchical-DHT, so that the sharing of content between distributed peers is facilitated and so that an optimum P2P live streaming service can be provided among the peers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a Peer-to-Peer (P2P) live streaming service over a Content Distribution Network (CDN), comprising the steps of:
(A) a peer present on a network searching for an adjacent surrogate, that is, a superpeer in a bin where peers are grouped;
(B) the peer sending a content request message to the surrogate;
(C) the surrogate finding a corresponding peer list and then sending the peer list to the peer in response to the content request message, or, if the surrogate cannot find a peer list corresponding to the content request message and makes a request to a surrogate overlay, the surrogate overlay sending information about a surrogate having corresponding content to the peer; and
(D) the peer requesting content from the surrogate having sent the peer list or from a surrogate included in the information about a surrogate, and receiving the corresponding content.

2. The method as set forth in claim 1, wherein at the step (A), peers having an identical ordering of a plurality of landmarks ordered based on calculated distances between each peer to the plurality of landmarks are grouped in the bin.

3. The method as set forth in claim 1, wherein at step (C), the information about a surrogate sent by the surrogate overlay comprises a surrogate ID corresponding to the content and a number of peers grouped into the corresponding surrogate, which have been received from some other surrogate and are being maintained.

4. The method as set forth in claim 3, wherein if each of the surrogate ID and the number of peers grouped into the corresponding surrogate comprises a plurality of pieces of information, the peer requests the content from a surrogate corresponding to a surrogate ID having a largest number of grouped peers at step (D).

5. The method as set forth in claim 1, wherein each peer present on the network maintains a peer list corresponding to each piece of content while randomly communicating with the surrogate, periodically updates a view of other peers and information about a state of each peer and then stores them in memory in accordance with a gossip protocol, and provides notification thereof to the surrogate so that they can be used to select a peer list.

6. The method as set forth in claim 1, wherein the surrogate overlay divides a predetermined Control Area Network (CAN) zone based on a number of landmarks present across a network, and locates a plurality of surrogates in respective CAN zones in such a way that surrogates having an identical bin are located in an identical CAN zone, thereby determining the information about a surrogate so that close peers first belong thereto by means of locality-based awareness.

7. A system for providing a P2P live streaming service over a CDN, comprising:
a plurality of surrogates, each of the surrogates being a superpeer in a bin in which different peers distributed across a network are grouped; and
a surrogate overlay configured to manage the plurality of surrogates;
wherein a found adjacent surrogate finds a corresponding peer list and then sends the peer list to the peer in response to the content request message sent to the surrogate, or, if the surrogate cannot find a peer list corresponding to the content request message and makes a request to the surrogate overlay, the surrogate overlay sends information about a surrogate having corresponding content to the peer; and
wherein the peer requests content from the surrogate having sent the peer list or from a surrogate included in the information about a surrogate, and receives the corresponding content.

8. The system as set forth in claim 7, wherein peers having an identical ordering of a plurality of landmarks ordered based on calculated distances between each peer to the plurality of landmarks are grouped in the bin.

9. The system as set forth in claim 7, wherein the information about a surrogate sent by the surrogate overlay comprises a surrogate ID corresponding to the content and a number of peers grouped into the corresponding surrogate, which have been received from some other surrogate and are being maintained.

10. The system as set forth in claim 9, wherein if each of the surrogate IDs and the number of peers grouped to the corresponding surrogate comprises a plurality of pieces of information, the peer requests the content from a surrogate corresponding to a surrogate ID having a largest number of grouped peers at step (D).

11. The system as set forth in claim 7, wherein each of the peers present on the network maintains a peer list corresponding to each piece of content while randomly communicating with the surrogate, periodically updates a view of other peers and information about a state of each peer and then stores them in memory in accordance with a gossip protocol, and provides notification thereof to the surrogate so that they can be used to select a peer list.

12. The system as set forth in claim 7, wherein the surrogate overlay divides a predetermined CAN zone based on a number of landmarks present across a network, and locates the plurality of surrogates in respective CAN zones in such a way that surrogates having an identical bin are located in an identical CAN zone, thereby determining the information about a surrogate so that close peers first belong thereto by means of locality-based awareness.
